(19) United States
(12) Patent Application Publication
(10) Pub. No.: US 2026/0283770 A1
(43) Pub. Date: Sep. 24, 2026

(54) COMSUMALBES OUTPUT CONTROL METHOD, DEVICE, TERMINAL AND READABLE STORAGE MEDIUM

(71) Applicant: DIMI LIFE TECHNOLOGY CO., LTD., Shenzhen, Guangdong (CN)

(72) Inventors: Yong HE, Shenzhen (CN); Wei HOU, Shenzhen (CN); Qinyang HE, Shenzhen (CN); Rongshan YI, Shenzhen (CN); Ning LIU, Shenzhen (CN)

(73) Assignee: DIMI LIFE TECHNOLOGY CO., LTD., Shenzhen, Guangdong (CN)

(21) Appl. No.: 18/873,735

(22) PCT Filed: Nov. 2, 2023
(86) PCT No.: PCT/CN2023/129281

§ 371 Date: Dec. 11, 2024

(51) Int. Cl. A61C 17/22; A46B 13/04; A46B 15/00

(52) U.S. Cl. CPC A61C 17/227; A46B 13/04; A46B 15/0004

(57) ABSTRACT

A consumable output control method, a device, a terminal device and a readable storage medium are provided. The consumable output control method includes: during a consumables output cycle of a consumables transfer pump of a smart terminal, obtaining a current value of the consumables transfer pump at preset intervals; determining an operating state of the consumable transfer pump during the consumable output cycle based on the current value; in the case that the operating state during the consumables output cycle is determined to be an unloaded state, adjusting an operating duration of the consumables output cycle.

### TECHNICAL FIELD

The present disclosure relates to the field of personal care device technology, in particular to a consumables output control method, device, terminal and a readable storage medium.

### BACKGROUND

For existing personal care equipment with the function of automatically outputting consumables, if too much consumables are pushed out, it is easy to cause waste, and may even have an impact on the user's health due to excessive consumption of consumables. Taking electric toothbrushes as an example, if too much toothpaste is pushed out, it will easily cause waste. On the other hand, it will also cause users to overuse toothpaste, causing oral health problems. It may even cause users to eat it by mistake, so that the fluoride of toothpaste will cause skeletal fluorosis and dental fluorosis. Therefore, it is necessary to accurately control the amount of consumables to be pushed out, so as to guide users to brush their teeth in a correct and healthy way.

However, since there is residual air in the consumables during filling, and after the personal care equipment is used for the first moment or has been cleaned, there is a possibility of air accumulation in the consumable pipelines, resulting in a large deviation in the amount of consumables pushed out of the personal care equipment each time, and the amount of consumables cannot be precisely controlled.

### SUMMARY

Embodiments of the present disclosure provide A consumable output control method, a device, a terminal device and a readable storage medium

In one aspect, the present disclosure provides in some embodiments a consumable output control method, including:
during a consumables output cycle of a consumables transfer pump of a smart terminal, obtaining a current value of the consumables transfer pump at preset intervals;
determining an operating state of the consumable transfer pump during the consumable output cycle based on the current value;
in the case that the operating state during the consumables output cycle is determined to be an unloaded state, adjusting an operating duration of the consumables output cycle.

Optionally, the determining the operating state of the consumable transfer pump during the consumable output cycle based on the current value comprises:
in the case that the current value is less than a first preset threshold, determining that the operating state of the consumable transfer pump is unloaded;
in the case that the current value is greater than or equal to the first preset threshold and less than a second preset threshold, determining that the operating state of the consumable transfer pump is loaded;
in the case that the current value is greater than or equal to a third preset threshold, determining that the operating state of the consumable transfer pump is stuck;
wherein the first preset threshold is smaller than the second preset threshold, and the second preset threshold is smaller than the third preset threshold.

Optionally, in the case that the operating state during the consumables output cycle is determined to be an unloaded state, adjusting an operating duration of the consumables output cycle includes:
determining a duration for which the consumable transfer pump is in the unloaded state;
adjusting the operation duration of the consumable output cycle according to the duration.

Optionally, the adjusting the operation duration of the consumable output cycle according to the duration includes:
determining a first moment when the consumable transfer pump enters the unloaded state and a second moment when the consumable transfer pump ends the unloaded state;
determining a first duration, wherein the first duration is a duration required for the consumables to be transferred from an input end of the consumable transfer pump to a consumable output end of the smart terminal;
determining a third moment when the consumable output cycle starts and a fourth moment when the consumable output cycle ends;
determining a compensation duration for the consumable output cycle based on the first moment, the second moment, the third moment, the fourth moment and the first duration;
adjusting the operation duration of the consumable output cycle according to the compensation duration.

Optionally, the determining the compensation duration for the consumable output cycle based on the first moment, the second moment, the third moment, the fourth moment and the first duration includes:
determining a fifth moment, wherein the fifth moment is a moment when the first duration is after the first moment;
determining a sixth moment, wherein the sixth moment is a moment when the first duration is after the second moment;
determining the compensation duration of the consumable output cycle according to the first moment, the second moment, the third moment, the fourth moment, the first duration, the fifth moment and the sixth moment.

Optionally, the determining the compensation duration of the consumable output cycle according to the first moment, the second moment, the third moment, the fourth moment, the first duration, the fifth moment and the sixth moment, includes:
if the fifth moment is later than the fourth moment, the compensation duration being 0.

Optionally, the determining the compensation duration of the consumable output cycle based on the first moment, the second moment, the third moment, the fourth moment, the first duration, the fifth moment and the sixth moment includes:
in the case that the fifth moment is earlier than the fourth moment, and the sixth moment is later than or equal to the fourth moment, the compensation duration being a duration from the fifth moment to the fourth moment.

Optionally, the determining the compensation duration of the consumable output cycle based on the first moment, the second moment, the third moment, the fourth moment, the first duration, the fifth moment and the sixth moment includes:
in the case that the fourth moment is later than the sixth moment, the compensation duration being a duration from the first moment to the second moment.

Optionally, the consumable output control method further includes:
in the case that the operation state of the consumable transfer pump is stuck during the consumable output cycle, switching a rotation direction of the consumable transfer pump;
after controlling the consumable transfer pump to operate a reverse direction for a preset duration, switching the operation direction of the consumable transfer pump to be a forward direction;
compensating the preset duration for the consumable output cycle.

In a second aspect, an embodiment of the present disclosure provides a consumable output control device, including:
an obtaining module, configured to obtain a current value of the consumable transfer pump of the smart terminal at preset intervals during the consumable output cycle of the consumable transfer pump;
a determining module, configured to determine an operating state of the consumable transfer pump during the consumable output cycle according to the current value;
an adjusting module, configured to adjust the operation duration of the consumable output cycle in the case that the operation state is determined to be an unloaded state.

In a thirds aspect, an embodiment of the present disclosure provides a consumables output control device, comprising: a current sampling device, a consumable transfer pump, and the consumable output control device;
wherein the current sampling device is connected to the consumables transfer pump and the consumables output control device;
the current sampling device is configured to collect a current value consumed during the operation of the consumable transfer pump, and send the current value to the consumable output control device.

Optionally, a diameter of an output end of the consumable transfer pump ranges from 0.6 mm to 2.8 mm.

In a fourth aspect, an embodiment of the present disclosure provides a terminal device, including: a transceiver, a processor, a memory, and a program or instructions stored on the memory and executed by the processor; wherein the processor executes the program or the instructions to implement the consumable output control method.

In a fifth aspect, an embodiment of the present disclosure provides a readable storage medium, with a computer program stored on the readable storage medium, wherein the computer program is executed by a processor to implement the steps of the consumable output control method.

### BRIEF DESCRIPTION OF THE DRAWINGS

FIG. 1 is a schematic diagram of the steps of a consumable output control method according to an embodiment of the present disclosure;

FIG. 2 is a schematic module diagram of an intelligent terminal according to an embodiment of the present disclosure;

FIG. 3 is a schematic structural diagram of a control circuit according to an embodiment of the present disclosure;

FIG. 4 is a schematic structural diagram of an intelligent terminal according to an embodiment of the present disclosure;

FIG. 5 is a schematic diagrams of the compensation duration of the consumable output cycle according to an embodiment of the present disclosure;

FIG. 6 is another schematic diagram of the compensation duration of the consumable output cycle according to an embodiment of the present disclosure;

FIG. 7 is yet another schematic diagram of the compensation duration of the consumable output cycle according to the embodiment of the present disclosure;

FIG. 8 is still yet another schematic diagram of the compensation duration of the consumable output cycle according to the embodiment of the present disclosure;

FIG. 9 is a schematic structural diagram of a consumable output control device according to an embodiment of the present disclosure;

FIG. 10 is a schematic structural diagram of a consumable output control apparatus according to an embodiment of the present disclosure;

FIG. 11 is a schematic structural diagram of a terminal device according to an embodiment of the present disclosure.

### DETAILED DESCRIPTION

The following will clearly and completely describe the technical solutions in the embodiments of the present disclosure with reference to the accompanying drawings. Obviously, the described embodiments are only some of the embodiments of the present disclosure, not all of them. Based on the embodiments in the present disclosure, all other embodiments obtained by those ordinary skill in the art without making creative work belong to the protection scope of the present disclosure.

The terms “first”, “second”, etc. in the description and claims of the present disclosure are used to distinguish similar objects and are not used to describe a specific order or sequence. It is to be understood that the data so used are interchangeable under appropriate circumstances, so that embodiments of the present disclosure can be practiced in sequences other than those illustrated or described herein. In addition, “and/or” in the description and claims indicates at least one of the connected objects, and the character “/” generally indicates that the related objects are in an “or” relationship.

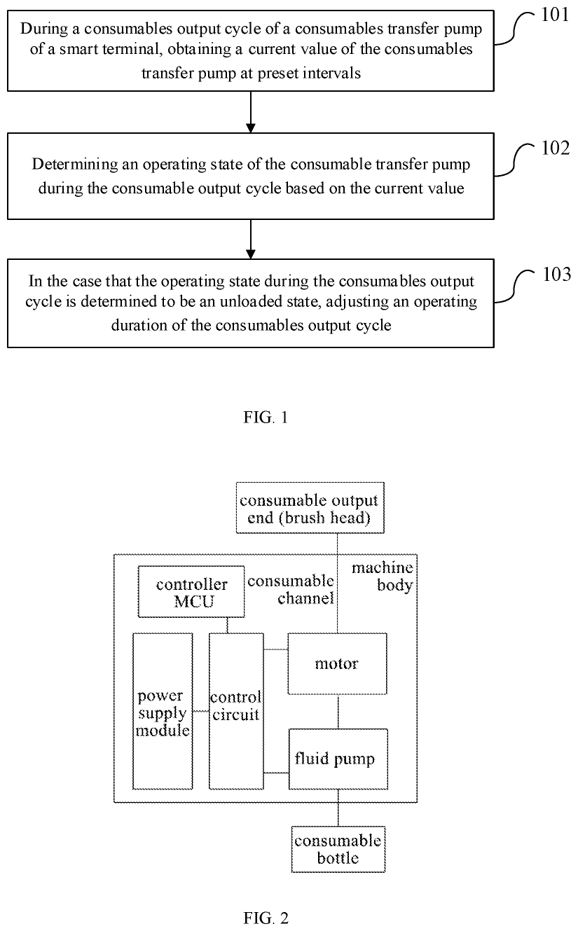

The consumable output control method provided by an embodiment of the present disclosure will be described in detail below with reference to FIGS. 1 to 11 through specific embodiments and application scenarios.

As shown in FIG. 1, the consumable output control method according to the embodiment of the present disclosure includes the following steps:
Step 101: During a consumables output cycle of a consumables transfer pump of a smart terminal, obtaining a current value of the consumables transfer pump at preset intervals;
Step 102: Determining an operating state of the consumable transfer pump during the consumable output cycle based on the current value;
Step 103: In the case that the operating state during the consumables output cycle is determined to be an unloaded state, adjusting an operating duration of the consumables output cycle.

Optionally, the preset interval can be set to as short a time as possible, for example, the preset interval is 1 second.

It should be noted that the smart terminal can be a smart toothbrush, a beauty device or a skin care device, and the consumables can be toothpaste or skin care products; the smart terminal includes a consumable bottle (such as a toothpaste bottle), a consumable transfer pump, and a consumable transfer channel. and a consumables output end (such as a toothbrush head or a skin care product output head); the two interfaces of the consumables transfer pump are respectively connected to the consumables bottle and the consumables transfer channel;

Wherein, the consumables are transferred from the consumables bottle to the consumables output end through the consumables transfer channel through the consumables transfer pump.

As shown in FIG. 2, in the embodiment of the present disclosure, the consumable transfer pump is a fluid pump. The fluid pump is driven by a motor, and the motor and fluid pump are connected through a controller (Microcontroller Unit, MCU) and a control circuit, so that the consumables are output from the consumable bottle to the consumable output end.

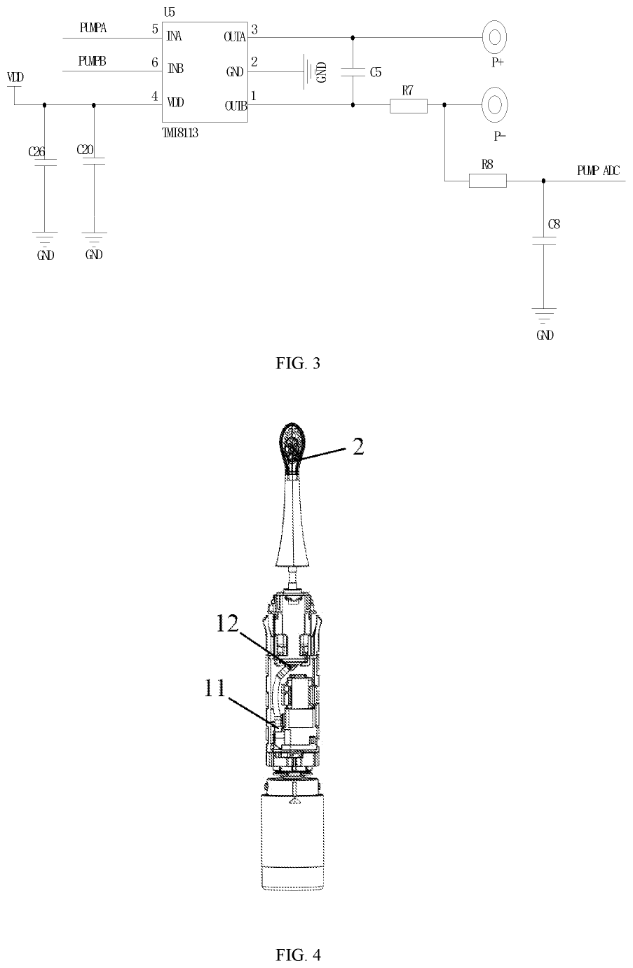

In an embodiment of the present disclosure, the current value of the consumable transfer pump is collected through a control circuit. The circuit diagram of the control circuit is shown in FIG. 3:

The control circuit is connected in series to the circuit of the consumable transfer pump through the first resistor R7 to divide the voltage;

The current value of the consumable transfer pump is collected through the second resistor R8 or the capacitor C8, and the collected current value is sent to the controller, so that the controller can obtain the current value of the consumable transfer pump in real time, the controller controls the operating parameters of the consumable transfer pump according to the current value, such as the rotation speed, gear ratio and operating duration of the consumable transfer pump.

Optionally, the consumable transfer pump is one of an air pump, a peristaltic pump, a gear pump, a screw pump and a rotor pump.

The consumables output control method of the embodiment of the present disclosure can determine the operating state of the consumables transfer pump through the collected current value consumed by the consumables transfer pump, thereby adjusting the operation duration of the consumable transfer pump under the case that the consumables transfer pump is determined to be an unloaded operating state. The operation duration of the consumable transfer pump can be extended when bubbles exist during the transfer of consumables, thereby ensuring the stability of the output amount of consumables. Embodiments of the present disclosure solve the problem that the personal care device cannot ensure the consistency and stability of output amount of consumables due to the presence of air bubbles during the filling of consumables or the presence of air in the consumable pipelines.

Optionally, determining the operating state of the consumable transfer pump during the consumable output cycle based on the current value includes:

In the case that the current value is less than a first preset threshold, determining that the operating state of the consumable transfer pump is unloaded;

In the case that the current value is greater than or equal to the first preset threshold and less than a second preset threshold, determining that the operating state of the consumable transfer pump is loaded;

In the case that the current value is greater than or equal to a third preset threshold, determining that the operating state of the consumable transfer pump is stuck;

Wherein, the first preset threshold is smaller than the second preset threshold, and the second preset threshold is smaller than the third preset threshold.

Optionally, the operating state of the consumable transfer pump is determined by the current value of the consumable transfer pump;

Specifically, the operating state of the consumable transfer pump is determined by detecting the current value of the consumable transfer pump.

It should be noted that during the operation of the consumable transfer pump, if it is under normal load, the current value of the consumable transfer pump will be within a relatively stable range;

During the operation of the consumable transfer pump, if there is no load, the current value of the consumable transfer pump will become smaller;

During the operation of the consumable transfer pump, if the consumable transfer pump gets stuck, the impedance of the consumable transfer pump decreases sharply and the current value increases rapidly. However, because the hardware resistor R7 is connected in series inside the circuit, the current can be clamped at a relatively safe range.

In the embodiment of the present disclosure, during the operation of the consumable transfer pump, if the current value of the consumable transfer pump is less than the first preset threshold, it is determined that the consumable transfer pump is in an unloaded state;

If the current value of the consumable transfer pump is less than the first preset threshold, it is determined that the consumable transfer pump is in an unloaded state (that is, the currently transferred consumables contain bubbles);

If the current value of the consumable transfer pump is greater than or equal to the first preset threshold and less than the second preset threshold, it is determined that the consumable transfer pump is in a load state (that is, there are no bubbles in the currently transferred consumables);

If the current value of the consumable transfer pump is greater than or equal to the third preset threshold, it is determined that the consumable transfer pump is in a stuck state;

Wherein, the first preset threshold may be 200 mA, the second preset threshold may be 300 mA, and the third preset threshold may be 500 mA.

Optionally, when it is determined that the operation state during the consumables output cycle is an unloaded state, adjusting the operation duration of the consumables output cycle includes:

Determining a duration for which the consumable transfer pump is in the unloaded state;

Adjusting the operation duration of the consumable output cycle according to the duration.

The consumables output control method of the embodiment of the present disclosure can determine the time occupied by the transmission of bubbles in the current consumables output cycle by detecting the duration of the consumables transfer pump to be in the unloaded state, thereby extending the operation duration of the consumables output cycle to compensate for the time occupied by the transmission of bubbles and ensure the consistency and stability of the consumables transmission volume in each consumables transmission cycle.

Optionally, adjusting the operation duration of the consumable output cycle according to the duration includes:

Determining a first moment when the consumable transfer pump enters the unloaded state and a second moment when the consumable transfer pump ends the unloaded state;

Determining a first duration, which is the duration required for the consumables to be transferred from an input end of the consumable transfer pump to a consumable output end of the smart terminal;

Determining a third moment when the consumable output cycle starts and a fourth moment when the consumable output cycle ends;

Determining a compensation duration for the consumable output cycle based on the first moment, the second moment, the third moment, the fourth moment and the first duration;

Adjusting the operation duration of the consumable output cycle according to the compensation duration.

It should be noted that the first duration is determined through pre-measurement;

Wherein, the first duration is a duration required from the consumables are transferred from the input end of the consumables transfer pump (i.e., the connection point between the consumables transfer pump and the consumables bottle) to the consumables output end of the smart terminal (such as a smart toothbrush head or a skin care product output header).

It should be noted that the consumable output cycle is a preset duration, and the consumables transmitted in each consumable output cycle are the amount of consumables used by the smart terminal at one time;

Among them, first, the amount of consumables required each time is determined;

Then, the consumable output cycle is determined based on the amount of consumables and the flow rate of the smart terminal transmitting the consumables.

In the embodiment of the present disclosure, the flow rate of the consumables transmitted by the smart terminal can be measured through testing (for example, when the entire cavity is filled with consumables, 10 S of consumables are fixedly pushed out, and the consumables are weighed, for example, the weight is 5 g, then the flow rate of the consumables is 0.5 g/s), and then the time when the consumables need to be pushed out (that is, the consumables output cycle) is calculated according to the actual demand for the consumables.

The consumable output control method of the embodiment of the present disclosure determine the compensation duration required for the consumable output cycle by determining the first moment when the consumable transfer pump enters the unloaded state, the second moment when the consumable transfer pump ends the unloaded state, the third moment when the consumable output cycle starts, the fourth moment when the consumable output cycle ends; and based on the pre-measured first duration, thereby ensuring the consistency of the amount of consumables transmitted in each of the consumable output cycles.

Optionally, determining the compensation duration for the consumable output cycle based on the first moment, the second moment, the third moment, the fourth moment and the first duration includes:

Determining a fifth moment, wherein the fifth moment is a moment when the first duration is after the first moment;

Determining a sixth moment, wherein the sixth moment is a moment when the first duration is after the second moment;

Determining the compensation duration of the consumable output cycle according to the first moment, the second moment, the third moment, the fourth moment, the first duration, the fifth moment and the sixth moment.

In the embodiment of the present disclosure, the consumable transfer pump being in an unloaded state can be understood to mean that there are bubbles in the currently transferred consumables;

The first moment can be understood as the moment when bubbles enter the consumable transfer pump, and the second moment can be understood as the moment when the bubble pump is at the consumable transfer pump;

The fifth moment is a moment when the first duration is after the first moment, that is, the fifth moment can be understood as the moment when the bubbles begin to arrive at the output end of the smart terminal, and the sixth moment can be understood as the moment when the bubbles is completely discharged from the smart terminal.

As shown in FIG. 4, in an embodiment of the present disclosure, the smart terminal is a smart toothbrush, and the consumables transfer pump is a toothpaste transfer pump 1;

The first moment when the consumable transfer pump enters the unloaded state is the time t1 when the bubbles begin to enter the input end 11 of the consumable transfer pump, and the second moment when the consumable transfer pump ends the unloaded state is the time t2 when the bubbles are discharged from output end 12 of the consumables transfer pump;

The first duration is the time At required for the consumables to be transferred from the input end 11 of the consumable transfer pump to the consumable output end 2;

The third moment is t3, and the fourth moment is t4;

The fifth moment is the time t5=t1+Δt when the bubbles are transmitted to the consumable output end 2;

The sixth moment is the time t6=t2+Δt when the bubbles are completely discharged from the consumable output end 2.

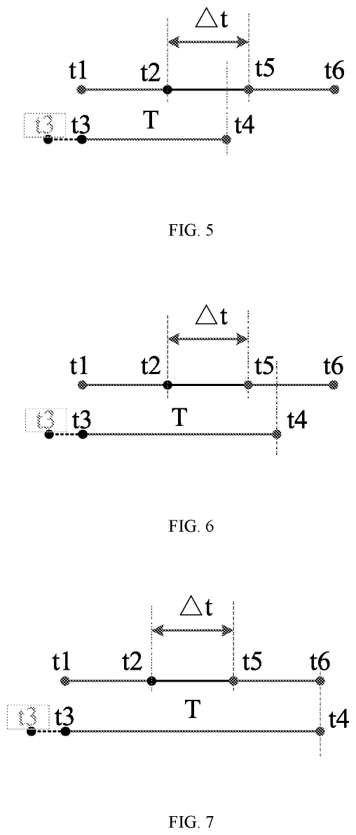

Optionally, as shown in FIG. 5, the determining the compensation duration for the consumable output cycle according to the first moment, the second moment, the third moment, the fourth moment, the first duration, the fifth moment and the sixth moment, includes:

If the fifth moment is later than the fourth moment, the compensation duration is 0.

It should be noted that the current values are collected within the consumables output cycle, that is, the first moment and the second moment are both within the consumables output period;

The fifth moment t5 is later than the fourth moment t4. It can be understood that there are bubbles in the consumables output period T, but after the consumables output period T ends, the bubbles are still in the consumables transfer channel, and do not reach the consumable output end of the smart terminal, so there is no need to compensate for the operation duration of the consumable output cycle.

The consumables output control method of the embodiment of the present disclosure can determine whether the bubbles existing in the consumables output cycle arrive at the consumables output end of the smart terminal before the end of the consumables output cycle, based on the sequence relationship between the fifth moment and the fourth moment, so as to determine the compensation duration for the consumables output cycle. The solution of the present disclosure can calculate the actual transmission time of consumables during the consumables output cycle, thereby determining whether a sufficient amount of consumables has been transmitted during the consumables output cycle, thereby ensuring the consistency and stability of the transmission amount of consumables by the terminal.

Optionally, the determining the compensation duration for the consumable output cycle based on the first moment, the second moment, the third moment, the fourth moment, the first duration, the fifth moment and the sixth moment includes:

In the case that the fifth moment is earlier than the fourth moment, and the sixth moment is later than or equal to the fourth moment, the compensation duration is a duration from the fifth moment to the fourth moment.

It should be noted that, as shown in FIG. 6, the fifth moment t5 is earlier than the fourth moment t4, and the sixth moment t6 is later than the fourth moment t4. It can be understood that when bubbles exist in the consumables output cycle T and the bubbles arrive at the consumables output end of the smart terminal before the end of the consumables output cycle T, and at the same time, the bubbles are not completely discharged from the consumables output end of the smart terminal at the end of the consumables output cycle T, only the duration from the fifth moment t5 to the fourth moment t4 (transmission duration of the bubble discharge) is compensated for the consumable output cycle;

At the same time, as shown in FIG. 7, the fifth moment t5 is earlier than the fourth moment t4, and the sixth moment t6 is equal to the fourth moment t4. It can be understood that the bubbles exist during the consumable output cycle T, and the bubbles arrive at the consumables output end of the smart terminal before the end of the consumables output cycle, and at the same time, at the end of the consumables output cycle T, the bubbles are just completely discharged from the consumables output end of the smart terminal. At this time, the duration from the fifth moment t5 to the fourth moment t4 is the duration from the fifth moment t5 to the sixth moment t6, which is equal to the duration from the first moment t1 to the second moment t2.

The consumables output control method of the embodiment of the present disclosure can determine whether the bubbles existing in the consumables output cycle arrive at the consumables output end of the smart terminal before the end of the consumables output cycle, based on the sequence relationship between the fifth moment and the fourth moment, determine whether the bubbles existing in the consumables output cycle arrive at the consumables output end of the smart terminal before the end of the consumables output cycle, based on the sequence relationship between the sixth moment and the fourth moment, so as to determine the compensation duration for the consumables output cycle. The solution of the present disclosure can calculate the actual transmission time of consumables during the consumables output cycle, thereby determining whether a sufficient amount of consumables has been transmitted during the consumables output cycle, thereby ensuring the consistency and stability of the transmission amount of consumables by the terminal.

The determining the compensation duration of the consumable output cycle based on the first moment, the second moment, the third moment, the fourth moment, the first duration, the fifth moment and the sixth moment includes:

In the case that the fourth moment is later than the sixth moment, the compensation duration is a duration between the first moment and the second moment.

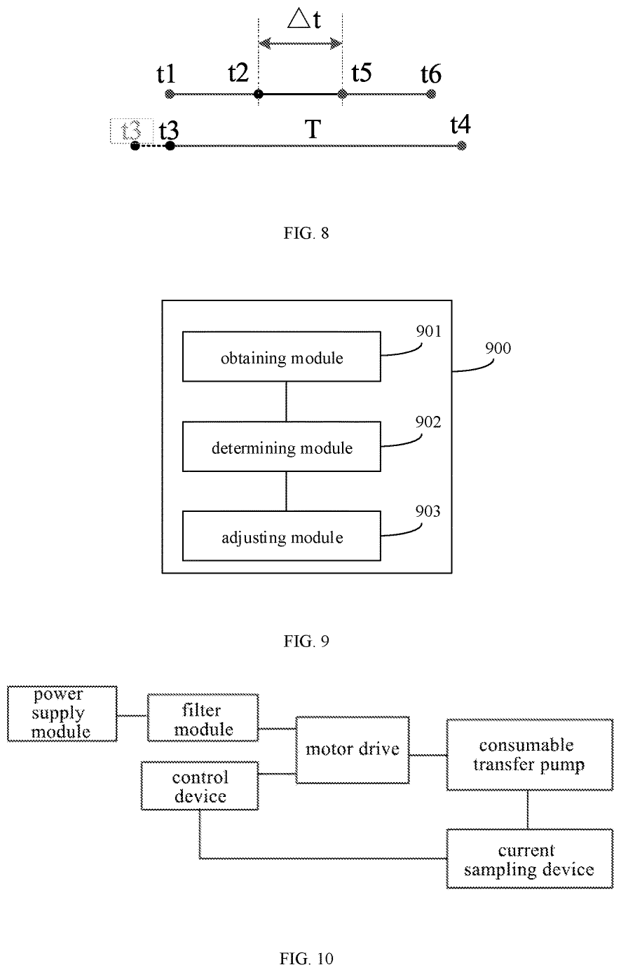

It should be noted that, as shown in FIG. 8, the fourth moment t4 is later than the sixth moment t6. It can be understood that before the end of the consumable output cycle T, the bubbles will completely discharge the consumable output end of the smart terminal, so the compensation duration is the transmission duration of the entire bubble.

The consumables output control method of the embodiment of the present disclosure can determine whether the bubbles existing in the consumables output cycle arrive at the consumables output end of the smart terminal before the end of the consumables output cycle, based on the sequence relationship between the sixth moment and the fourth moment, so as to determine the compensation duration for the consumables output cycle. The solution of the present disclosure can calculate the actual transmission time of consumables during the consumables output cycle, thereby determining whether a sufficient amount of consumables has been transmitted during the consumables output cycle, thereby ensuring the consistency and stability of the transmission amount of consumables by the terminal.

Optionally, the method further includes:

In the case that the operation state of the consumable transfer pump is stuck during the consumable output cycle, switching a rotation direction of the consumable transfer pump;

After controlling the consumable transfer pump to operate a reverse direction for a preset duration, switching the operation direction of the consumable transfer pump to operate in a forward direction;

The preset duration is compensated for the consumable output cycle.

As shown in FIG. 3, when it is determined that the operation state of the consumable transfer pump is stuck, the controller MCU enters the reverse push mode, that is, by controlling the level jump of the pins PUMPA and PUMPB, thereby causing the power supply pins P+ and P− levels of consumable transfer pump to be reversed, thereby realizing the reverse rotation of the consumable transfer pump, pushing out the impurities that cause the consumable transfer pump to jam, and returning the consumable transfer pump to normal operation.

Optionally, the preset duration is shorter than the consumable output cycle.

In the embodiment of the present disclosure, when the controller MCU detects that the current exceeds the third threshold, it starts recording the current time T_on;

At this time, the MCU will enter the protection reverse push mode and reverse the levels of PUMPA and PUMPB. At this time, the levels of the power supply pins P+ and P− of the consumable transfer pump will also reverse, and the consumable transfer pump can run in a reverse direction for a period of time (for example, 10 S), in this way, the impurities that cause the consumable transfer pump to get stuck can be pushed out of the machine, cause the consumable transfer pump to be the normal operation;

The MCU will continue to record the current. If the stuck state of the consumable transfer pump is released, the current will reduce to a safe range, and T on will be reset to zero; but if the pump body remains stuck until the stuck time exceeds the threshold (stuck duration=current time T_now−T_on, if the stuck duration>the set threshold, it is determined that the stuck state cannot be automatically released).

The consumables output control method of the embodiment of the present disclosure can determine that the consumables transfer pump is in a stuck state by controlling the current of the consumables transfer pump to be greater than the third preset threshold; and by controlling the operation direction of the consumables transfer pump, the impurities causing the consumable transfer pump to become stuck can be discharged from the consumable transfer pump, thereby restoring the normal operation of the consumable transfer pump.

As shown in FIG. 9, an embodiment of the present disclosure provides a consumable output control device 900, which includes:

An obtaining module 901, configured to obtain a current value of the consumable transfer pump of the smart terminal at preset intervals during the consumable output cycle of the consumable transfer pump;

A determining module 902, configured to determine an operating state of the consumable transfer pump during the consumable output cycle according to the current value;

An adjusting module 903, configured to adjust the operation duration of the consumable output cycle in the case that it is determined that the operation state is in an unloaded state.

The consumables output control device in the embodiment of the present disclosure can determine the operating state of the consumables transfer pump through the collected current value consumed by the consumables transfer pump, thereby adjusting the operation duration of the consumable transfer pump in the case that it is determined that the consumables transfer pump is in an unloaded operating state. The operation time of the consumable transfer pump can be extended when bubbles exist during the transfer of consumables, thereby ensuring the stability of the output of consumables. Embodiments of the present disclosure solve the problem that the personal care equipment cannot maintain consistency and stability of the consumable output amount due to the presence of air bubbles during the filling of consumables or the presence of air in the consumable pipelines.

As shown in FIG. 10, an embodiment of the present disclosure provides a consumable output control device, including: a current sampling device, a consumable transfer pump, and the consumable output control device as described above;

Wherein, the current sampling device is connected to the consumables transfer pump and the consumables output control device;

The current sampling device is configured to collect the current value consumed during the operation of the consumable transfer pump, and send the current value to the consumable output control device.

Optionally, the diameter of the output end of the consumable transfer pump ranges from 0.6 mm to 2.8 mm.

Optionally, the diameter of the output end of the consumable transfer pump is smaller than or equal to the diameter of the input end of the consumable transfer pump; and the diameter of the output end of the consumable transfer pump is smaller than the diameter of the output end of the consumable bottle.

The consumable output control device of the embodiment of the present disclosure can form a larger pressure area at the output end when the consumable passes through the output end by setting the diameter of the output end of the consumable transfer pump to 0.6 mm-2.8 mm. It is convenient for the current sampling device to transmit the current value consumed during the operation of the consumable transfer pump, and the accuracy of current collection by the current sampling device is improved.

Optionally, the consumable output control device also includes:

Consumable transfer pump, motor drive, filter module and power supply module.

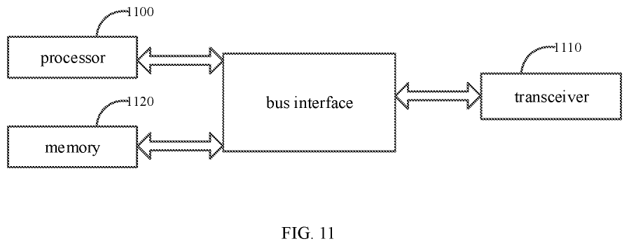

As shown in FIG. 11, an embodiment of the present disclosure provides a terminal device, including: a transceiver 1110, a processor 1100, a memory 1120, and a program or instructions on the memory and executable on the processor; when the processor executes the program or instruction, the consumable output control method as described above is implemented.

Embodiments of the present disclosure provide a readable storage medium on which a computer program is stored. When the computer program is executed by a processor, the steps of the above method are implemented.

The above descriptions are implementations of the present disclosure. It should be pointed out that those skilled in the art can make some improvements and modifications without departing from the principle of the present disclosure. These improvements and modifications shall also fall within the scope of the present disclosure.

1. A consumable output control method, comprising:
during a consumables output cycle of a consumables transfer pump of a smart terminal, obtaining a current value of the consumables transfer pump at preset intervals;
determining an operating state of the consumable transfer pump during the consumable output cycle based on the current value;
in the case that the operating state during the consumables output cycle is determined to be an unloaded state, adjusting an operating duration of the consumables output cycle.

2. The consumables output control method according to claim 1, wherein the determining the operating state of the consumable transfer pump during the consumable output cycle based on the current value comprises:
in the case that the current value is less than a first preset threshold, determining that the operating state of the consumable transfer pump is unloaded;
in the case that the current value is greater than or equal to the first preset threshold and less than a second preset threshold, determining that the operating state of the consumable transfer pump is loaded;
in the case that the current value is greater than or equal to a third preset threshold, determining that the operating state of the consumable transfer pump is stuck;
wherein the first preset threshold is smaller than the second preset threshold, and the second preset threshold is smaller than the third preset threshold.

3. The consumables output control method according to claim 1, wherein in the case that the operating state during the consumables output cycle is determined to be an unloaded state, adjusting an operating duration of the consumables output cycle comprises:
determining a duration for which the consumable transfer pump is in the unloaded state;
adjusting the operation duration of the consumable output cycle according to the duration.

4. The consumables output control method according to claim 3, wherein the adjusting the operation duration of the consumable output cycle according to the duration includes:
determining a first moment when the consumable transfer pump enters the unloaded state and a second moment when the consumable transfer pump ends the unloaded state;
determining a first duration, wherein the first duration is a duration required for the consumables to be transferred from an input end of the consumable transfer pump to a consumable output end of the smart terminal;
determining a third moment when the consumable output cycle starts and a fourth moment when the consumable output cycle ends;
determining a compensation duration for the consumable output cycle based on the first moment, the second moment, the third moment, the fourth moment and the first duration;
adjusting the operation duration of the consumable output cycle according to the compensation duration.

5. The consumable output control method according to claim 4, wherein the determining the compensation duration for the consumable output cycle based on the first moment, the second moment, the third moment, the fourth moment and the first duration comprises:
determining a fifth moment, wherein the fifth moment is a moment when the first duration is after the first moment;
determining a sixth moment, wherein the sixth moment is a moment when the first duration is after the second moment;
determining the compensation duration of the consumable output cycle according to the first moment, the second moment, the third moment, the fourth moment, the first duration, the fifth moment and the sixth moment.

6. The consumable output control method according to claim 5, wherein the determining the compensation duration of the consumable output cycle according to the first moment, the second moment, the third moment, the fourth moment, the first duration, the fifth moment and the sixth moment, comprises:
if the fifth moment is later than the fourth moment, the compensation duration being 0.

7. The consumable output control method according to claim 5, wherein the determining the compensation duration of the consumable output cycle based on the first moment, the second moment, the third moment, the fourth moment, the first duration, the fifth moment and the sixth moment comprises:
in the case that the fifth moment is earlier than the fourth moment, and the sixth moment is later than or equal to the fourth moment, the compensation duration being a duration from the fifth moment to the fourth moment.

8. The consumable output control method according to claim 5, wherein the determining the compensation duration of the consumable output cycle based on the first moment, the second moment, the third moment, the fourth moment, the first duration, the fifth moment and the sixth moment comprises:
in the case that the fourth moment is later than the sixth moment, the compensation duration being a duration from the first moment to the second moment.

9. The consumable output control method according to claim 1, further comprising:
in the case that the operation state of the consumable transfer pump is stuck during the consumable output cycle, switching a rotation direction of the consumable transfer pump;
after controlling the consumable transfer pump to operate a reverse direction for a preset duration, switching the operation direction of the consumable transfer pump to be a forward direction;
compensating the preset duration for the consumable output cycle.

10. A consumable output control device, comprising:
an obtaining module, configured to obtain a current value of the consumable transfer pump of the smart terminal at preset intervals during the consumable output cycle of the consumable transfer pump;
a determining module, configured to determine an operating state of the consumable transfer pump during the consumable output cycle according to the current value;
an adjusting module, configured to adjust the operation duration of the consumable output cycle in the case that the operation state is determined to be an unloaded state.

11. A consumables output control device, comprising: a current sampling device, a consumable transfer pump, and the consumable output control device according to claim 10;
wherein the current sampling device is connected to the consumables transfer pump and the consumables output control device;
the current sampling device is configured to collect a current value consumed during the operation of the consumable transfer pump, and send the current value to the consumable output control device.

12. The consumable output control device according to claim 11, wherein a diameter of an output end of the consumable transfer pump ranges from 0.6 mm to 2.8 mm.

13. A terminal device, comprising: a transceiver, a processor, a memory, and a program or instructions stored on the memory and executed by the processor; wherein the processor executes the program or the instructions to implement the consumable output control method according to claim 1.

14. A readable storage medium, with a computer program stored on the readable storage medium, wherein the computer program is executed by a processor to implement the steps of the consumable output control method according to claim 1.

15. The consumables output control method according to claim 2, wherein in the case that the operating state during the consumables output cycle is determined to be an unloaded state, adjusting an operating duration of the consumables output cycle comprises:
determining a duration for which the consumable transfer pump is in the unloaded state;
adjusting the operation duration of the consumable output cycle according to the duration.

16. The consumables output control method according to claim 5, wherein the smart terminal is a smart toothbrush, and the consumables transfer pump is a toothpaste transfer pump;
the first moment is a moment when bubbles begin to enter an input end of the consumable transfer pump;
the second moment is a moment when the bubbles are discharged from an output end of the consumables transfer pump;
the first duration is a duration required for the consumables to be transferred from the input end of the consumable transfer pump to the consumable output end;
the fifth moment is a moment when the bubbles are transmitted to the consumable output end;
the sixth moment is a moment when the bubbles are completely discharged from the consumable output end.

17. The consumables output control method according to claim 9, wherein the switching a rotation direction of the consumable transfer pump comprises:
controlling level jump of input pins of a controller to cause levels of power supply pins of the consumable transfer pump to be reversed;
wherein the preset duration is shorter than the consumable output cycle.

18. The consumable output control device according to claim 10, wherein the consumable transfer pump is one of an air pump, a peristaltic pump, a gear pump, a screw pump and a rotor pump, and the smart terminal is a smart toothbrush, a beauty device or a skin care device.

19. The consumable output control device according to claim 10, further comprising a control circuit configured to collect the current value of the consumable transfer pump, wherein the control circuit comprises a first resistor, a second resistor and a capacitor,
the first resistor is used to divide voltage of a circuit of the consumable transfer pump;
the second resistor or the capacitor is used to collect the current value of the consumable transfer pump, and send the collected current value a controller, so that the controller controls operating parameters of the consumable transfer pump based on the current value.

20. The consumable output control device according to claim 19, wherein the operating parameters comprises a rotation speed, a gear ratio and an operating duration of the consumable transfer pump.
